(19) United States
(12) Patent Application Publication
(10) Pub. No.: US 2006/0117902 A1
(43) Pub. Date: Jun. 8, 2006

(54) Pedal assembly with an integrated non-contact rotational position sensor

(76) Inventors: Tom Martin, Ft. Wayne, IN (US); David A. McKeeman JR., Ft. Wayne, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/998,530

(22) Filed: Nov. 29, 2004

(51) Int. Cl. G05G 1/14

(52) U.S. Cl. 74/512

(57) ABSTRACT

A pedal assembly including a pedal support and a pedal arm. The pedal arm includes a lever portion and an integral pivot portion arranged along a pivot axis. The pivot portion is rotatably engaged with the pedal support to provide pivotal movement of the pedal arm about the pivot axis. A magnetic field generator providing a magnetic field is engaged with the pivot portion such that pivotal movement of the pedal arm results in rotational displacement of the magnetic field about the pivot axis. A sensor device is engaged with the pedal support and comprises at least one magnetic flux sensor positioned within the magnetic field to sense variations in the magnetic field during rotational displacement and to generate an output signal representative of a rotational position of the magnetic field relative to the magnetic flux sensor.

### FIELD OF THE INVENTION

The present invention generally relates to the field of rotational position sensors, and more specifically relates to a pedal assembly including an integrated non-contact rotational position sensor.

### BACKGROUND

Pedal assemblies are used in association with a wide variety of vehicles to control various functions and accessories associated with operation of the vehicle. Such pedal assemblies may include, for example, accelerator pedals, brake pedals and/or clutch pedals that are linked to throttle, braking and shifting systems to control movement of the vehicle. Additionally, electronic position sensors are sometimes provided to monitor the position of the pedal arm and to provide an electronic signal to a control system that corresponds to the sensed position of the pedal arm. The performance criteria associated with the use of electronic position sensors may be quite high. This is particularly true in the automotive industry. For example, in some instances, the linearity of the electronic output signal corresponding to the position of the pedal arm must be less than ±1%, and the correlation between multiple electronic output signals must be less than ±2%. Additionally, manufacturing and assembly costs related to the use of electronic position sensors in association with pedal assemblies must also be taken into consideration.

Various types of electronic position sensors have been used to monitor the position of a pedal arm. In some cases, magnetic position sensors have been used to monitor pedal arm position while avoiding contact with the components of the pedal arm. These types of non-contact magnetic position sensors typically include a magnetic field generator coupled to the pedal arm which generates a magnetic field, and a magnetic field sensor that detects a change in the position of the magnetic field and generates an electronic output signal in response to such change. Prior pedal designs using non-contact sensors have been relatively complex and have required multiple parts and components to mount the magnetic field generator to the pedal arm and/or to position the magnetic field sensor in the correct location and orientation relative to the magnetic field generator. As a result, manufacturing and assembly costs associated with prior pedal sensor designs have been quite high. Additionally, the use of multiple parts and components to mount the magnetic field generator to the pedal arm and/or to correctly position the magnetic field sensor results in significant stack up tolerances which negatively impact sensor performance.

Thus, there is a general need in the industry to provide an improved pedal assembly including an integrated non-contact rotational position sensor. The present invention meets this need and provides other benefits and advantages in a novel and unobvious manner.

### SUMMARY

The present invention relates generally to rotational position sensors. While the actual nature of the invention covered herein can only be determined with reference to the claims appended hereto, certain forms of the invention that are characteristic of the preferred embodiments disclosed herein are described briefly as follows.

In one form of the present invention, a pedal assembly is provided including a pedal support adapted for mounting to the vehicle, and a pedal arm including a lever portion and an integral pivot portion arranged along a pivot axis. The pivot portion of the pedal arm is rotatably engaged directly with the pedal support to provide pivotal movement of the pedal arm relative to the pedal support about the pivot axis. A magnetic field generator providing a magnetic field is integrally engaged directly with the pivot portion such that pivotal movement of the pedal arm results in rotational displacement of the magnetic field about the pivot axis. A sensor device is integrally engaged directly with the pedal support and comprises at least one magnetic flux sensor positioned within the magnetic field to sense variations in the magnetic field during rotational displacement and to generate an output signal representative of a rotational position of the magnetic field relative to the magnetic flux sensor.

In another form of the present invention, a pedal assembly is provided including a pedal support adapted for mounting to the vehicle, and a pedal arm pivotally engaged with the pedal support to provide pivotal movement of the pedal arm relative to the pedal support about a pivot axis. A magnetic field generator is coupled with the pedal arm and is positioned and arranged to provide a magnetic field intersecting the pivot axis, with pivotal movement of the pedal arm resulting in rotational displacement of the magnetic field about the pivot axis. A sensor device is coupled with the pedal support and comprises at least one magnetic flux sensor arranged generally along the pivot axis and positioned within the magnetic field to sense variations in the magnetic field during rotational displacement and to generate an output signal representative of a rotational position of the magnetic field relative to the magnetic flux sensor.

In a further form of the present invention, a pedal assembly is provided including a pedal support adapted for mounting to the vehicle, and a pedal arm pivotally engaged with the pedal support to provide pivotal movement of the pedal arm relative to the pedal support about a pivot axis. A magnetic field generator providing a magnetic field is coupled with the pedal arm such that pivotal movement of the pedal arm results in rotational displacement of the magnetic field about the pivot axis. A sensor device is coupled with the pedal support and comprises at least one magnetic flux sensor positioned within the magnetic field to sense variations in the magnetic field during rotational displacement and to generate an output signal representative of a rotational position of the magnetic field relative to the magnetic flux sensor. A partition is positioned between the magnetic field generator and the sensor device.

In a further form of the present invention, a pedal assembly is provided including a pedal support adapted for mounting to the vehicle, and a pedal arm including a lever portion and an integral pivot shaft portion arranged along a pivot axis. The pivot portion is rotatably engaged within an opening defined by the pedal support to provide pivotal movement of the pedal arm relative to the pedal support about the pivot axis. A magnetic field generator providing a magnetic field is integrally engaged directly with the pivot shaft portion and is positioned and arranged to provide a magnetic field intersecting the pivot axis, with pivotal movement of the pedal arm resulting in rotational displacement of the magnetic field about the pivot axis. A sensor device is integrally engaged directly with the pedal support adjacent the opening and comprises at least one magnetic flux sensor arranged generally along the pivot axis and positioned within the magnetic field to sense variations in the magnetic field during rotational displacement and to generate an output signal representative of a rotational position of the magnetic field relative to the magnetic flux sensor.

It is one object of the present invention to provide an improved pedal assembly including an integrated non-contact rotational position sensor. Further objects, features, advantages, benefits, and further aspects of the present invention will become apparent from the drawings and description contained herein.

### BRIEF DESCRIPTION OF THE DRAWINGS

FIG. 1 is a side perspective view of pedal assembly according to one form of the present invention.

FIG. 2 is an exploded side perspective view of the pedal assembly illustrated in FIG. 1.

FIG. 3 is a side view of a proximal end portion of a pedal arm according to one embodiment of the present invention for use in association with the pedal assembly illustrated in FIG. 1.

FIG. 4 is a plan view of a magnetic circuit and a pair of magnetic flux sensors according to one embodiment of the present invention for use in association with the pedal assembly illustrated in FIG. 1.

FIG. 5 is a side view of the proximal end portion of the pedal arm illustrated in FIG. 3, and illustrating the assembled position of the magnetic flux sensors relative to the magnetic circuit.

FIG. 6 is a side view of a pedal support bracket according to one embodiment of the present invention for use in association with the pedal assembly illustrated in FIG. 1.

FIG. 7 is a side view of a sensor device according to one embodiment of the present invention for use in association with the pedal assembly illustrated in FIG. 1.

FIG. 8 is a side view of the pedal support bracket illustrated in FIG. 6, and illustrating the assembled position of the sensor device relative to the pedal support bracket.

FIG. 9 is a side view of the pedal assembly illustrated in FIG. 1, and illustrating the assembled position of the proximal end portion of the pedal arm relative to the pedal support bracket.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation on the scope of the invention is hereby intended, and that alterations and further modifications in the illustrated devices and further applications of the principles of the invention as illustrated herein are contemplated as would normally occur to one skilled in the art to which the invention relates.

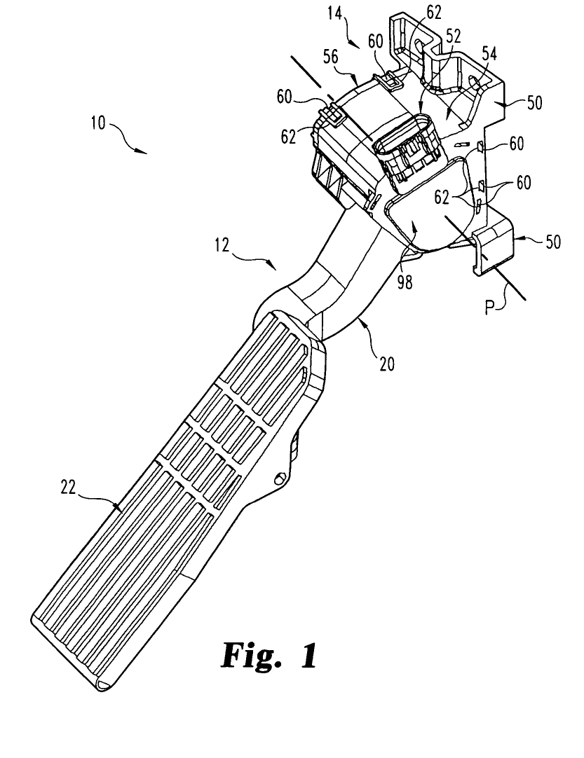

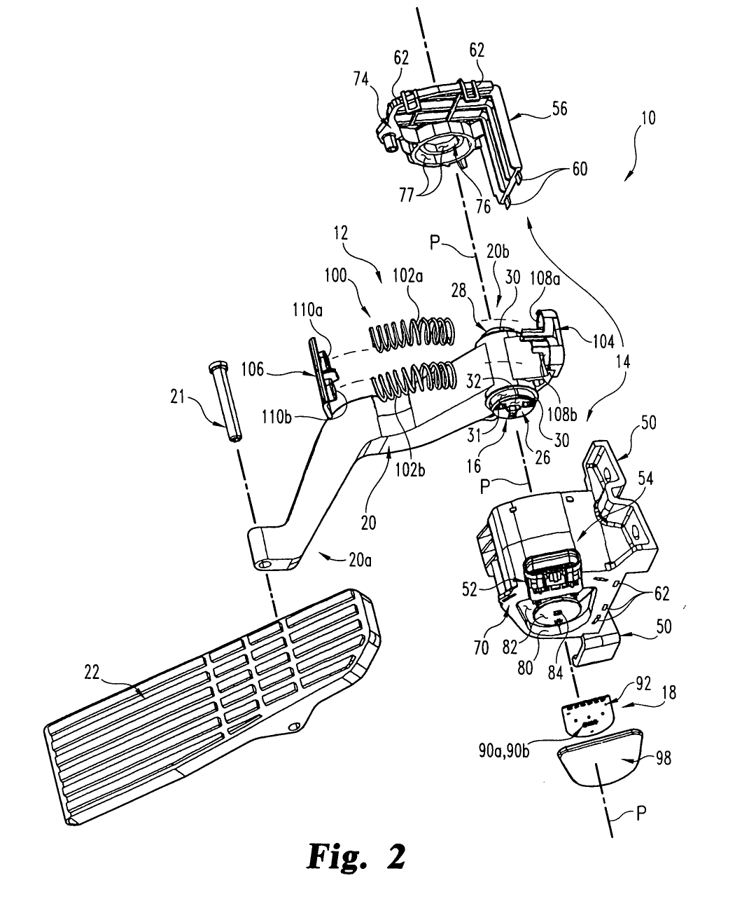

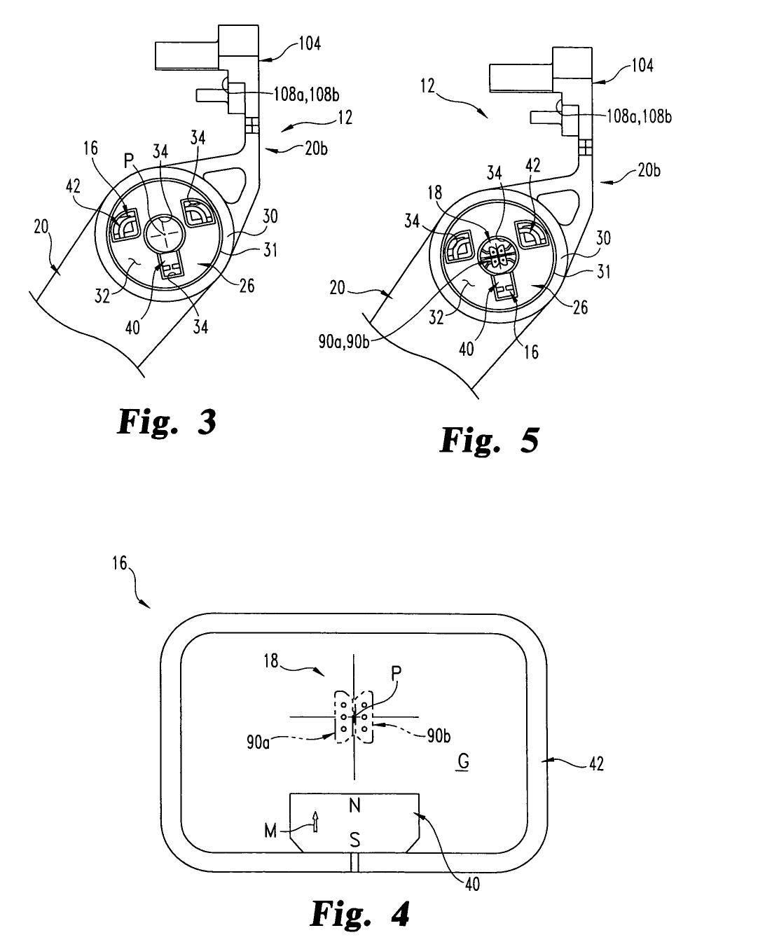

Referring to FIGS. 1 and 2, shown therein is a pedal assembly 10 according to one form of the present invention. The pedal assembly 10 generally includes a pedal arm 12, a pedal support 14, a magnetic field generator or magnetic circuit 16 (FIGS. 3-5), and a sensor device 18. The pedal support 14 is adapted for mounting to a vehicle, such as, for example, to the bulkhead or firewall of a vehicle. The pedal arm 12 is pivotally mounted to the pedal support 14 to allow pivotal movement of the pedal arm 12 about a pivot axis P. The magnetic circuit 16 generates a magnetic field and is engaged to the pedal arm 12 such that pivotal movement of the pedal arm 12 results in rotational displacement of the magnetic field about the pivot axis P. The sensor device 18 is engaged to the pedal support 14 and senses variations in the magnetic field during rotational displacement of the magnetic field, and also generates an output signal representative of the rotational position of the magnetic field and the pivotal position of the pedal arm 12. In one embodiment of the invention, the pedal assembly 10 is used in association with an accelerator pedal in an automotive vehicle to generate an electronic control signal corresponding to the pivotal position of the pedal arm 12 with the electronic signal controlling operation of a throttle valve. However, it should be understood that the pedal assembly 10 may also be used in association with other types of pedals to control other functions of a vehicle, such as, for example, braking or shifting. Further details regarding the components and operation of the pedal assembly 10 will be discussed below.

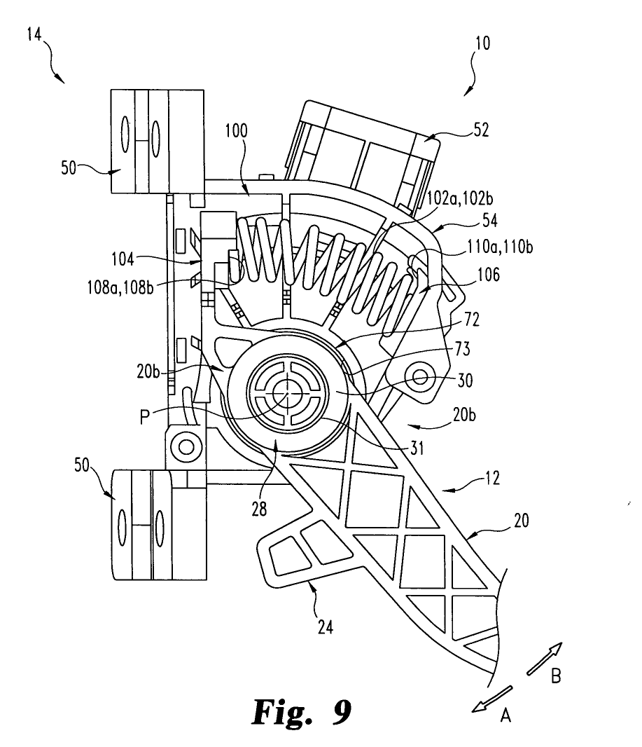

Referring collectively to FIGS. 1-5, in one embodiment of the invention, the pedal arm 12 includes an elongate lever portion 20 including a lower end 20a and an upper end 20b. A pedal pad or foot rest 22 is attached to the lower end 20a of the lever portion 20 by a pin 21. The pedal pad 22 is engaged by the operator of the vehicle to pivot the pedal arm 12 about the pivot axis P via exertion of a downward force onto the pedal pad 22. A stop or limit bar 24 (FIG. 9) may extend from the lever portion 20 to limit pivotal movement of the pedal arm 12. The pedal arm 12 also includes one or more pivot elements that cooperate with one or more corresponding pivot elements defined by the pedal support 14 to allow pivotal movement of the pedal arm 12 about the pivot axis P. In one embodiment of the invention, the pivot elements associated with the pedal arm 12 comprise a pair of shaft or stem portions 26, 28 extending transversely from the upper end 20b of the lever portion 20 in opposite directions and positioned along the pivot axis P. As will be discussed below, the pivot shaft portions 26, 28 are positioned within cavities formed in the pedal support 14 to allow pivotal movement of the pedal arm 12 relative to the pedal support 14 about the pivot axis P.

In one embodiment of the invention, the pivot shaft portions 26, 28 each have a substantially circular outer cross section to facilitate rotation of the pivot shaft portions 26, 28 within the cavities formed in the pedal support 14. However, other shapes and configurations are also contemplated as falling within the scope of the present invention. The pivot shaft portions 26, 28 are integral with the lever portion 20 to provide an integrated pedal arm structure. Further, in one embodiment of the invention, the pedal arm 12 is formed of a plastic material and is produced via an injection molding technique such that the lever arm portion 20 and the pivot shaft portions 26, 28 are formed as a single-piece, unitary pedal arm structure. However, the pedal arm 12 may be formed of other materials, such as, for example, steel or aluminum, and may be produced via other forming, casting, fabrication or manufacturing techniques. A bushing 30 defining an outer circumferential bearing surface 31 may be positioned about each of the pivot shaft portions 26, 28 to minimize friction and wear between the pedal arm 12 and the pedal support 14. The bushing 30 can either be co-molded with the pedal arm 12 or may be fabricated separately and press fit onto the pivot shaft portions 26, 28.

As shown most clearly in FIG. 3, the magnetic circuit 16 is attached directly to the pedal arm 12, and more specifically to the pivot shaft portion 26 extending from the lever portion 20. In this manner, the magnetic circuit 16 is rotationally displaced relative to the pivot axis P during pivotal movement of the pedal arm 12, the purpose of which will be discussed below. In one embodiment of the invention, the magnetic circuit 16 is integral with the pivot shaft portion 26 of the pedal arm 12. In the illustrated embodiment, the magnetic circuit 16 is insert molded directly into the pivot shaft portion 26 of the pedal arm 12. In other embodiments of the invention, a cavity may be formed in the pivot shaft portion 26 into which the magnetic circuit 16 is subsequently press fit or otherwise inserted to form an integrated pedal arm/magnetic circuit assembly. However, it should be understood that other techniques for coupling the magnetic circuit 16 to the pedal arm 12 are also contemplated as falling within the scope of the present invention.

In one embodiment of the invention, the magnetic circuit 16 is at least partially positioned below an axially facing surface 32 (FIG. 3) of the pivot shaft portion 26. In a preferred embodiment, the entire magnetic circuit 16 is positioned below the axially facing surface 32 of the pivot shaft portion 26. As will be discussed in greater detail below, the magnetic circuit 16 defines an air gap G (FIG. 4) wherein a magnetic field is generated, with the sensor device 18 sensing changes in the magnetic field resulting from rotation of the magnetic field about the pivot axis P. As shown in FIG. 3, the pivot shaft portion 26 of the pedal arm 12 defines a cavity 34 extending from the axially facing surface 32 and positioned generally along the pivot axis P. The cavity 34 preferably extends into the air gap G defined the magnetic circuit 16 so as to position the cavity within the magnetic field generated by the magnetic circuit 16. The cavity 34 is in turn sized to receive one or more magnetic flux sensors associated with the sensor device 18 to thereby position the flux sensors within the magnetic field, the purpose of which will also be discussed below.

Although the magnetic circuit 16 is preferably disposed within the pivot shaft portion 26 in a recessed position below the axially-facing surface 32, it should be understood that the magnetic circuit 16 may alternatively be attached or otherwise engaged directly to the axially-facing surface 32 or to other portions of the pivot shaft portion 26. It should further be appreciated that by integrating the magnetic circuit 16 into the pivot shaft portion 26 of the pedal arm 12, stack up positional tolerances are significantly reduced relative to prior pedal designs that position the magnetic circuit remote from pivot elements. Additionally, integrating the magnetic circuit 16 into the pivot shaft portion 26 of the pedal arm 12 eliminates the need for a separate rotor or other connector elements that are prevalent in prior pedal designs. As a result, the overall design of the pedal assembly 10 is simplified, thereby reducing manufacturing and assembly costs. As mentioned above, positional tolerances are also significantly reduced so as to improve the performance characteristics associated with the pedal assembly 10.

As shown in FIG. 4, the magnetic circuit 16 includes a single magnet 40 and an outer loop pole piece or flux ring 42, with the magnet 40 and the pole piece 42 cooperating to generate a magnetic field within the inner region of the loop pole piece 42. The magnetic circuit 16 is particularly well suited for integration into the pedal arm 12 because of its relatively compact size and its ability to be positioned and arranged along the pivot axis P. In one embodiment of the invention, the magnetic circuit 16 is positioned and arranged such that the magnetic field extends transversely across and intersects the pivot axis P. However, it should be understood that other types, configurations and arrangements of magnetic circuits capable of producing a magnetic field are also contemplated for use in association with the present invention. For example, in another embodiment, the magnetic circuit 16 need not necessarily include the loop pole piece 42 to generate a suitable magnetic field. Additionally, the magnetic circuit 16 may include two or more magnets 40 to generate a suitable magnetic field. It should be understood that the particular magnetic circuit 16 illustrated and described above is exemplary, and that other types and configurations of magnetic circuits are also suitable for use in association with the present invention. For example, U.S. Pat. Nos. 6,137,288, 6,310,473, 6,417,664 and 6,472,865 and U.S. Patent Application Publication No. 2003/0132745, all commonly assigned to the Assignee of the subject application, disclose various types and configurations of magnetic circuits suitable for use in association with the present invention, the contents of which are hereby incorporated by reference in their entirety.

In one embodiment of the invention, the magnet 40 is a rare earth magnet having a substantially rectangular configuration. However, it should be understood that other types of magnets having different shapes and configurations are also contemplated for use in association with the present invention. Additionally, the pole piece 42 is formed of a magnetically permeable material, such as, for example, a soft magnetic steel or cold rolled steel and has a substantially rectangular configuration. However, it should be understood that other types of pole pieces formed of other materials and having different shapes and configurations are also contemplated for use in association with the present invention. The magnet 40 is disposed within the inner region of the pole piece 42 with the magnet 40 positioned adjacent a portion of the pole piece 42 to provide an air gap G between the magnet 40 and an opposing portion of the pole piece 42. In the illustrated embodiment of the invention, a south pole surface S of the magnet 40 is positioned adjacent an inner surface of the pole piece 42 with the north pole surface N facing the air gap G. However, it should be understood that other positions and orientations of the magnet 40 relative to the pole piece 42 are also contemplated. Additionally, as should be appreciated, the magnet 40 and the pole piece 42 cooperate to generate a magnetic field within the air gap G. In one embodiment of the invention, the air gap G and the magnetic filed are positioned along the pivot axis P such that the magnetic field transversely intersects the pivot axis P, the purpose of which will become apparent below.

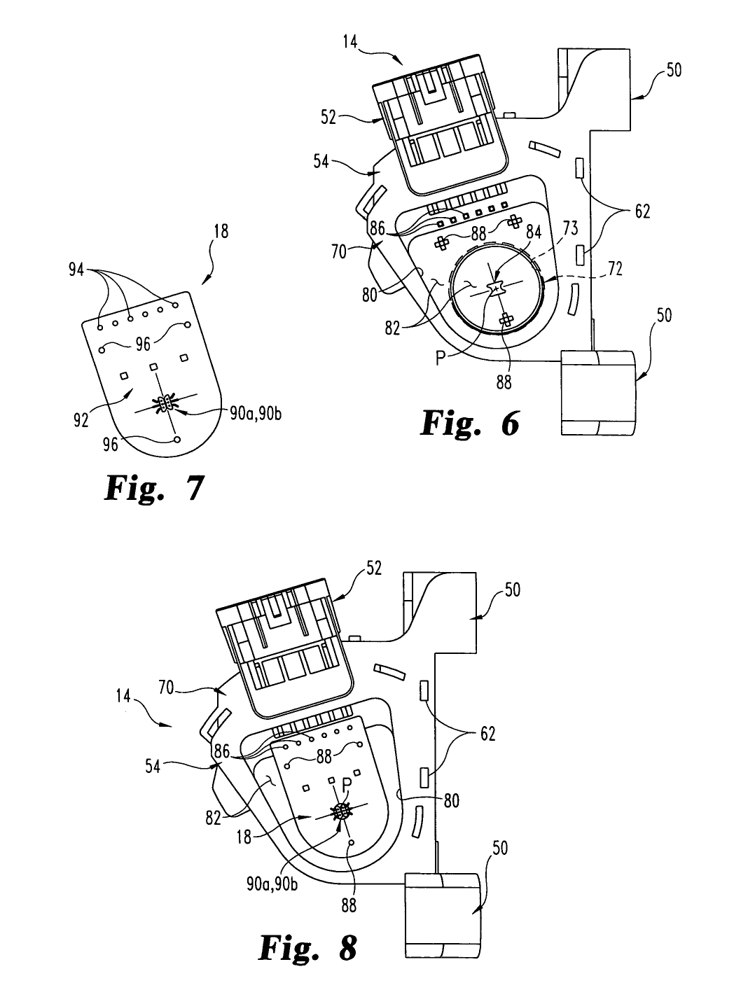

Referring collectively to FIGS. 2 and 6-8, in the illustrated embodiment of the invention, the pedal support 14 includes a number of mounting rails or feet 50 adapted to mount the pedal support 14 to the vehicle, and also includes an integral connector 52 for connecting the electronics associated with the non-contact position sensor (to be disclosed below) with a cable or wire harness, which is in turn connected to electronic circuitry or a vehicle control system such as a computer. In a preferred embodiment, the electrical connector 52 is molded directly into the pedal support 14.

The pedal support 14 is preferably formed as a two-piece structure including a primary mounting bracket 54 a secondary mounting bracket 56. As will become apparent, providing the pedal support 14 as a two-piece structure simplifies assembly of the pedal arm 12 with the pedal support 14. The primary and secondary mounting brackets 54, 56 each include a number of clips 60 and clip retainers 62 that function to selectively hold the mounting brackets 54, 56 together in the assembled configuration illustrated in FIG. 1. The mounting bracket portions 54, 56 may also be provided with a number of aligned openings for receiving fasteners (not shown) to further aid in selectively holding the mounting brackets 54, 56 together in an assembled configuration.

In one embodiment, the pedal support 14 is formed of a plastic material and is produced via an injection molding technique such that the primary mounting bracket 54 and the integral connector 52 may each be formed as a single-piece, unitary structure. However, it should be understood that the pedal support 14 may be formed of other materials, such as, for example, steel or aluminum, and may be produced via other forming, casting, fabrication or manufacturing techniques. It should further be understood that in other embodiments of the invention, the pedal support 14 may take on other configurations and may be formed as a single piece. Additionally, it should be appreciated that various elements and features illustrated and described below may be molded directly into the primary and secondary mounting brackets 54, 56 to simplify the design of the pedal assembly 10 and to reduce manufacturing and assembly costs.

In the illustrated embodiment of the invention, the primary mounting bracket 54 includes a lateral wall 70 defining an inwardly facing cavity 72 positioned along the pivot axis P and defining an inner circumferential bearing surface 73. Similarly, the secondary mounting bracket 56 includes a lateral wall 74 defining an inwardly facing cavity 76 positioned along the pivot axis P opposite the cavity 72 and defining an inner circumferential bearing surface 77. In one embodiment, the cavities 72, 76 and the bearing surfaces 73, 77 are molded directly into the primary and secondary mounting brackets 54, 56. However, other forming techniques are also contemplated as falling within the scope of the present invention. Additionally, the cavities 72, 76 may be defined by journals or bearings attached to the mounting brackets 54, 56. The cavity 72 formed in the primary mounting bracket 54 is sized and configured to receive the pivot shaft portion 26 of the pedal arm 12 therein. Similarly, the cavity 76 formed in the secondary mounting bracket 56 is sized and configured to receive the pivot shaft portion 28 of the pedal arm 12 therein. Although the illustrated embodiment of the invention depicts the pedal arm 12 as including the pivot shaft portions 26, 28 and the mounting brackets 54, 56 as defining the cavities 72, 76, in alternative embodiments, these elements may be reversed such that the pedal arm 12 defines the cavities 72, 76 and the mounting brackets 54, 56 include the pivot shaft portions 26, 28.

As should be appreciated, positioning of the pivot shaft portions 26, 28 within the cavities 72, 76 engages the pedal arm 12 to the pedal support 14 in a manner allowing pivotal movement of the pedal arm 12 about the pivot axis P, with the outer circumferential bearing surfaces 31 of the bushings 30 closely engaged with the inner circumferential bearing surfaces 73, 77 of the pedal support 14. As should also be appreciated, in the illustrated embodiment of the invention, pivotal engagement of the pedal arm 12 to the pedal support 14 does not require a separate pin or shaft passing through aligned openings in the pedal arm 12 and the pedal support 14, thereby reducing manufacturing and/or assembly costs and reducing stack up tolerances associated with the overall pedal assembly 10. As should further be appreciated, assembly of the pedal support 14 and the pedal arm 12 is accomplished by positioning the pivot shaft portion 26 of the pedal arm 12 within the cavity 72 in the primary mounting bracket 54, aligning the pivot shaft portion 28 with the cavity 76 in the secondary mounting bracket 56, and engaging the mounting brackets 24, 26 together to pivotally capture the pedal arm 12 between the lateral walls 70, 74 of the mounting brackets 54, 56. As should be appreciated, close engagement of the bearing surfaces 31 of the bushings 30 with the bearing surfaces 73, 77 of the mounting brackets 54, 56 accurately positions and maintains the pivot shaft portion 26 relative to the primary mounting bracket 54, which in turn accurately positions and maintains the magnetic circuit 16 (integral with the pivot shaft portion 26) relative to the sensing device 18 (integral with the primary mounting bracket 54).

In another embodiment of the invention, the lateral wall 70 of the primary mounting bracket 54 defines an outwardly facing recessed area 80 arranged generally opposite the inner cavity 72. In a preferred embodiment, the cavity 72 and the recessed area 80 do not intersect so as to provide a barrier wall or partition 82 between the inner cavity 72 and the outer recessed area 80. The barrier wall 82 isolates or seals the mechanical components of the pedal arm 12 and the magnetic circuit 16 positioned inside the pedal support 14 from the electrical components of the sensor device 18 positioned outside the pedal support 14. In a further embodiment of the invention, the barrier wall 82 defines a pocket or cavity 84 extending inwardly toward the inner cavity 72 and positioned generally along the pivot axis P. The pocket 84 is sized and configured to receive at least one magnetic flux sensor associated with the sensor device 18, further details of which will be discussed below.

In one embodiment of the invention, the primary mounting bracket 54 includes a number of electrical terminal pins 86 extending from the barrier wall 82 which are configured for connection to the sensor device 18 to electrically connect the sensor device 18 with the integral connector 52. The terminal pins 86 are preferably molded directly into the lateral wall 70 of the primary mounting bracket 54. The primary mounting bracket 54 further includes a number of locating elements 88 adjacent the barrier wall 82 which are configured to locate the sensor device 18 in the correct position and orientation relative to the primary mounting bracket 54 and to the magnetic circuit 16. The locating elements are also preferably molded directly into the lateral wall 70 of the primary mounting bracket 54. In one embodiment, the locating elements 88 are configured as a number of pins extending from the barrier wall 82. The locating elements 88 may also be configured to retain the sensor device 18 on the primary mounting bracket 54.

Referring collectively to FIGS. 7 and 8, in the illustrated embodiment of the invention, the sensor device 18 generally includes a pair of magnetic flux sensors 90a, 90b that are securely mounted and electrically connected to a printed circuit board (PCB) 92 which includes electronic circuitry associated with the operation of the magnetic flux sensors 90a, 90b. Although the sensor device 18 is illustrated and described as including a pair of magnetic flux sensors 90a, 90b, it should be understood that the sensor device 18 may include a single magnetic flux sensor or three or more magnetic flux sensors depending on the particular sensing requirements associated with the pedal assembly 10. Additionally, although the illustrated embodiment of the sensing device 18 depicts the magnetic flux sensors 90a, 90b as being directly connected to the printed circuit board (PCB) 92, it should be understood that in other embodiments the electronic circuitry associated with the magnetic flux sensors 90a, 90b may be located remote from the pedal assembly 10.

For purposes of the present invention, a “magnetic flux sensor” is broadly defined as any device that is operable to sense magnetic flux density and to generate an electronic signal representative of the magnitude of the magnetic flux density. In one embodiment of the invention, the magnetic flux sensors 90a, 90b are Hall effect devices that are capable of sensing magnetic flux density passing perpendicularly through the sensing plane of the device. In one embodiment, the Hall-effect devices are of the programmable type, however, non-programmable Hall-effect devices are also contemplated for use in association with the present invention. It should also be understood that other types of magnetic flux sensors are also contemplated for use in association with the present invention, including, for example, a magneto-resistive (MR) sensor, a magnetic diode sensor, or any other magnetic field-sensitive sensor device that would occur to one of skill in the art.

As would be appreciated by those of skill in the art, the functionality of a Hall-effect device is based on the physical principle that a voltage is generated transverse to the current flow direction in an electric conductor if a magnetic field is applied perpendicularly in a direction normal to the conductor. Typically, a Hall element comprises a small platelet that is formed of a semi-conductive material. In operation, the Hall element detects the magnitude of magnetic flux density passing through the Hall plate in a direction perpendicular to the surface of the Hall plate, and generates an output signal that is representative of the sensed magnitude of magnetic flux density. Preferably, the output signal is a voltage signal; however, other types of electronic output signals are also possible. Further details regarding the characteristics and operation of magnetic flux sensors, and particularly a Hall-effect type magnetic flux sensor, are disclosed in U.S. Pat. No. 6,137,288, the contents of which have been incorporated herein in their entirety.

In the illustrated embodiment of the sensor device 18, the printed circuit board 92 includes a number of terminal landings 94 configured for engagement with the terminal pins 86 extending from the recessed area 80 of the primary mounting bracket 54. In this manner, the sensor device 18 can be quickly and easily removed from the pedal support 14 for replacement by a different sensor device 18. In one embodiment of the invention, the terminal landings 94 are apertures that extend at least partially through the printed circuit board 92 and which are sized to receive the terminal pins 86 therein to electrically connect the sensor device 18 with the integral connector 52 and in turn to electrical equipment located remote from the pedal assembly 10. However, it should be understood that in other embodiments of the invention, a number of terminal pins may extend from the sensor device 18 for engagement with a corresponding number of terminal landing defined by the pedal support 14. It should be appreciated that positioning of the terminal pins 86 within the terminal apertures 94 also aids in locating the sensor device 18 in the appropriate position and orientation relative to the pedal support 14 and the magnetic circuit 16. Although the pedal assembly 10 has been illustrated and described as providing a particular electrical connection between the sensor device 18 and electrical equipment located remote from the pedal assembly 10, it should be understood that other types and configurations of electrical connections are also contemplated as falling within the scope of the present invention.

In the illustrated embodiment of the invention, the printed circuit board 92 includes a number of locating elements 96 that are configured to engage the locating elements 88 extending from the barrier wall 82 of the primary mounting bracket 54. Engagement between the locating elements 88 and 96 serves to locate/mount the sensor device 18 in the correct position and orientation relative to the primary mounting bracket 54 and the magnetic circuit 16 of the pedal arm 12. In one embodiment of the invention, the locating elements 96 are apertures that extend at least partially through the printed circuit board 92 and which are sized to receive the locating pins 88 of the primary mounting bracket 54 therein. However, it should be understood that in other embodiments of the invention, a number of locating pins may extend from the sensor device 18 for engagement within a corresponding number of locating apertures defined by the primary mounting bracket 54.

In the illustrated embodiment of the invention, the locating pins 88 and the locating apertures 96 are arranged in a triangular-shaped pattern, however, other configurations and arrangements are also contemplated. Additionally, the locating elements 88, 96 may be configured to retain the sensor device 18 on the primary mounting bracket 54. For example, in one embodiment, the locating pins 88 may be sized and configured to be press fit within the apertures 96 in the sensor device 18 to removably engage the sensor device 18 to the primary mounting bracket 54 without any additional fastening devices. In this manner, the sensor device 18 can be quickly and easily removed from the pedal support 14 for replacement by a different sensor device 18. Although the pedal assembly 10 has been illustrated and described as including a particular configuration of locating/retaining elements to engage the sensor device 18 to the primary mounting bracket 54, it should be understood that other types and configurations of locating/retaining elements are also contemplated as falling within the scope of the present invention.

As indicated above, the magnetic flux sensors 90a, 90b are securely mounted and electrically connected to a printed circuit board 92. In one embodiment, the magnetic flux sensors 90a, 90b extend perpendicularly from the printed circuit board 92 and are arranged in a back-to-back or face-to-face relationship such that the sensing planes associated with the magnetic flux sensors 90a, 90b are arranged generally parallel to one another with the pivot axis P extending between the sensors 90a, 90b. However, it should be understood that other positions and orientations of the magnetic flux sensors 90a, 90b are also contemplated. When the sensor device 18 is properly engaged to the primary mounting bracket 54, the magnetic flux sensors 90a, 90b are positioned within the pocket 84 formed in the barrier wall 82 of the primary mounting bracket 54, with the sensors 90a, 90b arranged generally along the pivot axis P. Additionally, when the pedal arm 12 is properly engaged to the primary mounting bracket 54, the pocket 84 containing the sensors 90a, 90b is positioned within the cavity 34 formed in the pivot shaft portion 26 of the pedal arm 12. As a result, the sensors 90a, 90b are positioned within the magnetic field generated by the magnetic circuit 16. As should be appreciated, the barrier wall 82 and the pocket 84 serve to isolate or seal the mechanical components associated with the pedal arm 12 and the magnetic circuit 16 from the electrical components associated with the sensor device 18 (the magnetic flux sensors 90a, 90b and the printed circuit board 92). A removable lid or cover 98 may be positioned over the recessed area 80 of the primary mounting bracket 54 to protect the sensor device 18 from the outer environment while still providing quick access to the recessed area 80 and the sensor device 18.

As should be appreciated, alignment of the sensor device 18 relative to the magnetic circuit 16 is significantly improved relative to prior pedal assembly designs due to the unique features and techniques used to mount the magnetic circuit 16 to the pedal arm 12 and the sensor device 18 to the pedal support 14. Specifically, since the magnetic circuit 16 is integrated into the pivot shaft portion 26 and since the sensor device 18 is integrated into the pedal support 14 and mounted in a select position and orientation, alignment concerns and stack up positional tolerances associated with prior pedal designs are significantly reduced. Additionally, integration of the sensor device 18 into the primary mounting bracket 54 of the pedal support 14 eliminates the need for a separate sensor housing, as required in various prior pedal designs. Although the magnetic circuit 16 is illustrated and described as being integral with the pivot shaft portion 26 and the magnetic flux sensors 90a, 90b are integrated into the primary mounting bracket 54, it should be understood that in other embodiments of the invention, the magnetic circuit 16 may be integrated into the primary mounting bracket 54 with the magnetic flux sensors 90a, 90b integrated into the pivot shaft portion 26.

Referring collectively to FIGS. 2 and 9, shown therein is a side view of the pedal assembly 10 illustrating the proximal end portion 20b of the lever portion 20 pivotally engaged with the primary mounting bracket 54 such that the pedal arm 12 is free to pivot relative to the pedal support 14 about the pivot axis P. In one embodiment of the invention, a biasing mechanism 100 is provided to bias the pedal arm 12 to the home or “at rest” position shown in FIGS. 1 and 9. In the illustrated embodiment, the biasing mechanism comprises a pair of coil springs 102a, 102b positioned between an upper portion 104 of the pedal arm 12 and an inner portion 106 of the pedal support 14. However, it should be understood that other types of biasing mechanisms are also contemplated as falling within the scope of the invention for urging the pedal arm 12 to the home or “at rest” position. Additionally, other types and configurations of springs may be used to urge the pedal arm 12 to the home or “at rest” position. Furthermore, although the illustrated embodiment of the invention includes a pair of coil springs 102a, 102b, it should be understood that any number of coil springs may be used, including a single coil spring or three or more coil springs.

In one embodiment of the invention, the upper portion 104 of the pedal arm 12 includes a pair of recessed areas 108a, 108b sized and configured to receive end portions of the coil springs 102a, 102b therein. Similarly, the inner portion 106 of the pedal support 14 includes a pair of recessed areas 110a, 110b sized and configured to receive end portions of the coil springs 102a, 102b therein. As a result, the coil springs 102a, 102b are securely nested and maintained in position between the pedal arm 12 and the pedal support 14. In the illustrated embodiment, the upper portion 104 of the pedal arm 12 is integral to the proximal end portion 20a of the lever portion 20. However, it should be understood that in other embodiments, the recessed spring nesting areas 108a, 108b may be formed in a separate bracket portion or in another portion of the pedal arm 12. Additionally, in the illustrated embodiment, the inner portion 106 of the pedal support 14 comprises a bracket plate that is separate from the primary mounting bracket 54. However, it should be understood that in other embodiments, the recessed spring nesting areas 110a, 110b of the bracket plate 106 may be formed directly into the primary mounting bracket 54 or another portion of the pedal support 14.

As illustrated in FIG. 9, when the operator of the vehicle exerts a downward force onto the pedal pad 22 (FIG. 1), the pedal arm 12 is pivoted about the pivot axis P in the direction of arrow A. As a result of the pivotal movement of the pedal arm 12 in the direction of arrow A, the coil springs 102a, 102b are compressed between the upper portion 104 of the pedal arm 12 and the inner portion 106 of the pedal support 14. As should be appreciated, when the operator of the vehicle removes or reduces the downward force onto the pedal pad 22, the compressed coil springs 102a, 102b will urge the pedal arm 12 in the direction of arrow B, back toward the home or “at rest” position illustrated in FIGS. 1 and 9.

Having described various structural features associated with the pedal assembly 10, reference will now be made to operation of the pedal assembly 10 according to one form of the present invention. As indicated above, the magnetic flux sensors 90a, 90b are positioned within the air gap G and the magnetic field generated by the magnetic circuit 16. The magnetic flux sensors 90a, 90b in turn sense varying magnitudes of magnetic flux density as the magnetic circuit 16 and the magnetic field are rotated about the pivot axis P in response to pivotal movement of the pedal arm 12. During rotational displacement of the magnetic circuit 16, the orientation of the sensing planes of the stationary magnetic flux sensors 90a, 90b will vary relative to the rotating magnetic field. As discussed above, if Hall devices are used, the sensed magnitude of magnetic flux density is measured in a direction perpendicular to the sensing plane of the Hall element. Accordingly, the sensed magnitude of magnetic flux density will be approximately zero when the sensing planes of the Hall devices are arranged generally parallel with the magnetic field (i.e., when the sensing planes are arranged generally along the direction of magnetization M of the magnet 40). Additionally, the sensed magnitude of magnetic flux density will be at its maximum when the sensing planes of the Hall devices are arranged generally perpendicular to the magnetic field (i.e., when the sensing planes are normal to the direction of magnetization M of the magnet 40).

It should be appreciated that the magnetic field strength or flux density detected by the magnetic flux sensors 90a, 90b is proportional to the rotational position of the magnetic field relative to the pivot axis P, which in turn directly corresponds to the pivotal position of the pedal arm 12 relative to the pivot axis P. In a preferred embodiment of the invention, the magnitude of the magnetic flux density sensed by the magnetic flux sensor 90a, 90b varies in a substantially linear manner as the magnetic field and the pedal arm 12 are displaced about the pivot axis P. Additionally, in response to variation in the sensed magnitude of magnetic flux density, the sensor device 18 generates an electronic voltage signal that is proportional to the sensed magnitude of magnetic flux density, which is in turn corresponds to the pivotal position of the pedal arm 12. Further details regarding the operation of various types and configurations of magnetic rotational position sensors are disclosed in U.S. Pat. No. 6,137,288, the contents of which have been incorporated herein in their entirety.

While the present invention has been illustrated and described in detail in the drawings and foregoing description, the same is to be considered as illustrative and not restrictive in character, it being understood that the preferred embodiment has been shown and described and that all changes and modifications that come within the spirit of the invention are desired to be protected.

What is claimed is:

1. A pedal assembly for use in association with a vehicle, comprising:
a pedal support adapted for mounting to the vehicle;
a pedal arm including a lever portion and an integral pivot portion arranged along a pivot axis, said pivot portion rotatably engaged directly with said pedal support to provide pivotal movement of said pedal arm relative to said pedal support;
a magnetic field generator providing a magnetic field and integrally engaged directly with said pivot portion such that said pivotal movement of said pedal arm results in rotational displacement of said magnetic field about said pivot axis; and
a sensor device integrally engaged directly with said pedal support and comprising at least one magnetic flux sensor positioned within said magnetic field to sense variations in said magnetic field during said rotational displacement and to generate an output signal representative of a rotational position of said magnetic field relative to said at least one magnetic flux sensor.

2. The pedal assembly of claim 1, wherein one of said pivot portion and said pedal support defines a pivot shaft extending along said pivot axis, another of said pivot portion and said pedal support defining an opening sized to rotatably receive said pivot shaft to pivotally engage said pedal arm to said pedal support.

3. The pedal assembly of claim 2, wherein said pivot portion of said pedal arm defines said pivot shaft extending transversely from said lever portion along said pivot axis; and
wherein said pedal support defines said opening sized to rotatably receive said pivot shaft.

4. The pedal assembly of claim 3, wherein said pivot shaft is formed integral with said lever portion to provide a unitary single-piece pedal arm structure.

5. The pedal assembly of claim 4, wherein said pivot shaft is molded with said lever portion to provide said unitary single-piece pedal arm structure.

6. The pedal assembly of claim 3, wherein said magnetic field generator is positioned along an axially facing surface of said pivot shaft.

7. The pedal assembly of claim 3, wherein said magnetic field generator is positioned within a cavity in said pivot shaft.

8. The pedal assembly of claim 7, wherein said magnetic field generator is at least partially positioned below an axially facing surface of said pivot shaft.

9. The pedal assembly of claim 8, wherein said magnetic field generator is positioned entirely below said axially facing surface of said pivot shaft.

10. The pedal assembly of claim 7, wherein said magnetic field generator is insert molded into said pivot shaft.

11. The pedal assembly of claim 2, wherein said pivot portion includes a bushing positioned about said pivot shaft and including an outer bearing surface engaged with an inner bearing surface defined by said opening.

12. The pedal assembly of claim 2, wherein said magnetic field generator is positioned within a cavity in said pivot portion of said pedal arm.

13. The pedal assembly of claim 12, wherein said magnetic field generator is insert molded into said pivot portion of said pedal arm.

14. The pedal assembly of claim 1, wherein said a magnetic field generator is positioned along said pivot axis.

15. The pedal assembly of claim 14, wherein said magnetic field transversely intersects said pivot axis.

16. The pedal assembly of claim 1, wherein said magnetic field generator includes at least one magnet and a loop pole piece defining an inner region, said magnet cooperating with said loop pole piece to generate said magnetic field within said inner region.

17. The pedal assembly of claim 16, wherein said inner region of said loop pole piece is positioned along said pivot axis.

18. The pedal assembly of claim 17, wherein said magnetic field transversely intersects said pivot axis.

19. The pedal assembly of claim 1, wherein said at least one magnetic flux sensor comprises a Hall-effect device.

20. The pedal assembly of claim 1, wherein said at least one magnetic flux sensor is positioned generally along said pivot axis.

21. The pedal assembly of claim 1, wherein said sensor device includes a pair of said magnetic flux sensors positioned within said magnetic field.

22. The pedal assembly of claim 21, wherein said pair of said magnetic flux sensors are arranged generally parallel to one another and positioned on opposite sides of said pivot axis.

23. The pedal assembly of claim 1, further comprising a partition positioned between said magnetic field generator and said sensor device.

24. The pedal assembly of claim 23, wherein said partition comprises a wall portion of said pedal support.

25. The pedal assembly of claim 23, wherein said partition defines a pocket extending into said magnetic field, said at least one magnetic flux sensor at least partially positioned within said pocket.

26. The pedal assembly of claim 25, wherein said pocket is positioned generally along said pivot axis.

27. The pedal assembly of claim 23, wherein said sensor device is engaged to said partition.

28. The pedal assembly of claim 27, wherein said partition defines a recessed area, said sensor device positioned within said recessed area.

29. The pedal assembly of claim 28, further comprising a cover removably positioned over said recessed area to protect said sensor device.

30. The pedal assembly of claim 1, wherein said pedal support includes a wall portion including a recessed area, said sensor device positioned within said recessed area with a cover removably positioned over said recessed area to protect said sensor device.

31. The pedal assembly of claim 1, wherein said sensor device includes a printed circuit board, said at least one magnetic flux sensor mounted and electrically connected to said printed circuit board.

32. The pedal assembly of claim 1, further comprising a plurality of first electrical terminal elements integral with said pedal support, said sensor device including a plurality of second electrical terminal elements selectively and removably engaged with said first electrical terminal elements.

33. The pedal assembly of claim 32, wherein said first electrical terminal elements comprise pins formed integral with said pedal support; and
wherein said second electrical terminal elements comprise apertures defined at least partially through said sensor device.

34. The pedal assembly of claim 32, wherein said first electrical terminal elements are insert molded into said pedal support.

35. The pedal assembly of claim 32, said pedal support includes an integral electrical connector electrically coupled to said first electrical terminal elements to electrically connect said sensor device with one or more electronic devices located remote from the pedal assembly.

36. The pedal assembly of claim 1, wherein said pedal support and said sensor device include locating elements that cooperate with one another to locate the at least one magnetic flux sensor in a select position and orientation relative to said magnetic field generator.

37. The pedal assembly of claim 36, wherein said locating elements comprise a number of locating pins formed integral with said pedal support and positioned within a corresponding number of locating apertures defined by said sensor device.

38. The pedal assembly of claim 1, further comprising an electrical connector formed integral with said pedal support and electrically connected between said sensor device and one or more electronic devices located remote from the pedal assembly.

39. The pedal assembly of claim 1, wherein said pedal support comprises a multi-piece structure including a first bracket portion and a second bracket portion, said first and second bracket portions selectively and removably engaged to one another with said pivot portion of said pedal arm pivotally engaged between said first and second bracket portions.

40. A pedal assembly for use in association with a vehicle, comprising:
a pedal support adapted for mounting to the vehicle;
a pedal arm pivotally engaged with said pedal support to provide pivotal movement of said pedal arm relative to said pedal support about a pivot axis;
a magnetic field generator coupled with said pedal arm and positioned and arranged to provide a magnetic field intersecting said pivot axis, said pivotal movement of said pedal arm resulting in rotational displacement of said magnetic field about said pivot axis; and
a sensor device coupled with said pedal support and comprising at least one magnetic flux sensor arranged generally along said pivot axis and positioned within said magnetic field to sense variations in said magnetic field during said rotational displacement and to generate an output signal representative of a rotational position of said magnetic field relative to said at least one magnetic flux sensor.

41. The pedal assembly of claim 40, wherein said pedal arm includes a lever portion and an integral pivot shaft portion arranged along said pivot axis, said pivot shaft portion rotatably engaged with said pedal support to provide said pivotal movement of said pedal arm relative to said pedal support.

42. The pedal assembly of claim 41, wherein said magnetic field generator is integrally engaged directly with said pivot shaft portion of said pedal arm.

43. The pedal assembly of claim 41, wherein said magnetic field generator is positioned along an axially facing surface of said pivot shaft portion.

44. The pedal assembly of claim 43, wherein said magnetic field generator is positioned within a cavity in said pivot shaft portion.

45. The pedal assembly of claim 44, wherein said magnetic field generator is insert molded into said pivot shaft portion.

46. The pedal assembly of claim 40, wherein said magnetic field generator includes at least one magnet and a loop pole piece defining an inner region, said magnet cooperating with said loop pole piece to generate said magnetic field within said inner region.

47. The pedal assembly of claim 40, further comprising a partition positioned between said magnetic field generator and said sensor device.

48. The pedal assembly of claim 47, wherein said partition defines a pocket extending into said magnetic field, said at least one magnetic flux sensor at least partially positioned within said pocket.

49. The pedal assembly of claim 47, wherein said partition defines a recessed area, said sensor device positioned within said recessed area with a cover removably positioned over said recessed area to protect said sensor device.

50. A pedal assembly for use in association with a vehicle, comprising:
a pedal support adapted for mounting to the vehicle;
a pedal arm pivotally engaged with said pedal support to provide pivotal movement of said pedal arm relative to said pedal support about a pivot axis;
a magnetic field generator providing a magnetic field and coupled with said pedal arm such that said pivotal movement of said pedal arm results in rotational displacement of said magnetic field about said pivot axis;
a sensor device coupled with said pedal support and comprising at least one magnetic flux sensor positioned within said magnetic field to sense variations in said magnetic field during said rotational displacement and to generate an output signal representative of a rotational position of said magnetic field relative to said at least one magnetic flux sensor; and
a partition positioned between said magnetic field generator and said sensor device.

51. The pedal assembly of claim 50, wherein said partition comprises a wall portion of said pedal support.

52. The pedal assembly of claim 50, wherein said partition defines a pocket extending into said magnetic field, said at least one magnetic flux sensor at least partially positioned within said pocket.

53. The pedal assembly of claim 52, wherein said pocket is positioned generally along said pivot axis.

54. The pedal assembly of claim 50, wherein said sensor device is engaged to said partition.

55. The pedal assembly of claim 50, wherein said partition defines a recessed area, said sensor device positioned within said recessed area.

56. The pedal assembly of claim 55, further comprising a cover removably positioned over said recessed area to protect said sensor device.

57. The pedal assembly of claim 50, wherein said magnetic field generator is positioned and arranged such that said magnetic field intersects said pivot axis.

58. The pedal assembly of claim 50, wherein said pedal arm includes a lever portion and an integral pivot shaft portion arranged along said pivot axis, said pivot shaft portion rotatably engaged with said pedal support to provide said pivotal movement of said pedal arm relative to said pedal support.

59. The pedal assembly of claim 58, wherein said magnetic field generator is integrally engaged directly with said pivot shaft portion of said pedal arm.

60. A pedal assembly for use in association with a vehicle, comprising:
a pedal support adapted for mounting to the vehicle;
a pedal arm including a lever portion and an integral pivot shaft portion arranged along a pivot axis, said pivot portion rotatably engaged with an opening defined by said pedal support to provide pivotal movement of said pedal arm relative to said pedal support;
a magnetic field generator providing a magnetic field and integrally engaged directly with said pivot shaft portion and positioned and arranged to provide a magnetic field intersecting said pivot axis with said pivotal movement of said pedal arm resulting in rotational displacement of said magnetic field about said pivot axis; and
a sensor device integrally engaged directly with said pedal support adjacent said opening and comprising at least one magnetic flux sensor arranged generally along said pivot axis and positioned within said magnetic field to sense variations in said magnetic field during said rotational displacement and to generate an output signal representative of a rotational position of said magnetic field relative to said at least one magnetic flux sensor.

61. The pedal assembly of claim 60, further comprising a partition positioned between said magnetic field generator and said sensor device.

62. The pedal assembly of claim 61, wherein said partition defines a pocket extending into said magnetic field, said at least one magnetic flux sensor at least partially positioned within said pocket.

63. The pedal assembly of claim 62, wherein said partition defines a recessed area, said sensor device positioned within said recessed area with a cover removably positioned over said recessed area to protect said sensor device.
